(19) United States
(12) Patent Application Publication
(10) Pub. No.: US 2005/0000542 A1
(43) Pub. Date: Jan. 6, 2005

(54) Devices, systems and methods for transporting a liquid

(76) Inventor: Jeff Williams, Allen, TX (US)

Correspondence Address: Steven Thrasher, 391 Sandhill Dr., Richardson, TX, 75080, US

(21) Appl. No.: 10/910,728

(22) Filed: Aug. 2, 2004

Related U.S. Application Data
(63) Continuation-in-part of application No. 09/883,634, filed on Jun. 18, 2001.

(51) Int. Cl. B08B 7/04; B08B 5/04

(52) U.S. Cl. 134/10; 134/21; 134/34; 134/56 R; 134/110; 134/111; 15/98; 15/260

(57) ABSTRACT

The invention provides devices, systems, and methods of operating a cleaning solution system that automatically disposes of dirty water and provides new water to a mop bucket. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS REFERENCE TO RELATED APPLICATIONS

The invention is a continuation in part of, is related to, and claims priority from United States Utility Patent Application Number 09/883,634, filed on Jun. 18, 2001, by Jeff Williams, and also entitled DEVICES, SYSTEMS AND METHODS FOR TRANSPORTING A LIQUID.

### TECHNICAL FIELD

Generally, the invention relates to the field of cleaning device, and more particularly, the invention relates to systems, methods, and devices for cleaning mops.

### STATEMENT OF A PROBLEM ADDRESSED BY THIS INVENTION

Persons who clean floors with floor cleaning tools (for simplicity of discussion, hereinafter, floor cleaning tools are referred to as mops), such as janitors, food service workers, or housekeepers, for example, must frequently clean the mops so that a mop actually cleans the floor, rather than merely swirl around dirt and debris. Generally, to keep a mop clean, the person must frequently dump used water from a mop bucket, and/or flush the mop bucket with soapy water or sanitized water. Accordingly, as the mop is cleaned, the water in the mop bucket becomes dirty. Often, this is done at a mop station.

A mop station generally comprises a sink, as well as a water hose, and a space for positioning a mop bucket so that it may be filled with water or other liquids. However, a sink at a mop station is typically elevated. This means that a person must lift the mop bucket to the sink to dump out dirty water. In addition, it is often necessary to fill the mop bucket with water. This is typically done in the sink, or at the sink's level. Thus, the mop bucket must be lowered to the floor level from the sink in order to avoid spilling water around the mop station. Unfortunately, because water weighs more than eight pounds per gallon, and because mop buckets often hold between three and six gallons of water, a full mop bucket may weigh in excess of fifty pounds. Predictably, the lifting and lowering of a mop bucket may cause injuries.

Riding “floor buffers” are just not economical for a vast majority of businesses, and require their own continuous independent water supply. Their size also limits the application of cleaner and water, and they are not easily storable. These are just some of the reasons riding floor buffers are less desirable than mop buckets and form their own independent field of art. Automated mop buckets (having pump motors attached) are also cumbersome, heavy, and have been shown to have little practicable use as their filters must be nearly continuously changed, and users of these buckets must constantly change their water, just like with a regular mop bucket. Thus, the user of these systems have all the disadvantages of a prior art mop bucket with the additional disadvantages of traveling power cords, weight, mechanical parts, and create an electrical hazard as electricity and water are simultaneously applied to a system (and, one which is often in use by a single, isolated person who cannot get to aid in the event of shock).

Back strain from the mop bucket lifting and lowering is a common workplace injury. According to the Department of Labor, overexertion is the leading cause of injuries for janitors and housekeepers. In fact, in the year 2000, 28% of workplace injuries were due to overexertion, and lifting caused half of those injuries. Accordingly, there exists the need for systems, devices, and methods that save worker time, prevent worker injury from lifting too much weight, prevent worker exposure to hazardous chemicals, and effectively provides the desired liquids to a work area, such as a mop station.

Accordingly, the invention provides inventive embodiments that save worker time, prevent worker injury from lifting too much weight, prevent worker exposure to hazardous chemicals, and effectively provides the desired liquids to a work area, such as a mop station. Thus, employers will save money due to increased worker productivity, lower insurance rates, fewer workers' compensation claims, and fewer OSHA violations.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is a flow diagram of a liquid transfer algorithm;

FIG. 2 illustrates a cleaning station algorithm;

FIG. 3 is one embodiment of a cleaning compound/fresh water device; And

FIG. 4 shows a cleaning compound/fresh water system.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. Further, elements and acts incorporate those elements and acts known, unknown, foreseeable, and unforeseeable, unless otherwise indicated.

Exemplary Methods

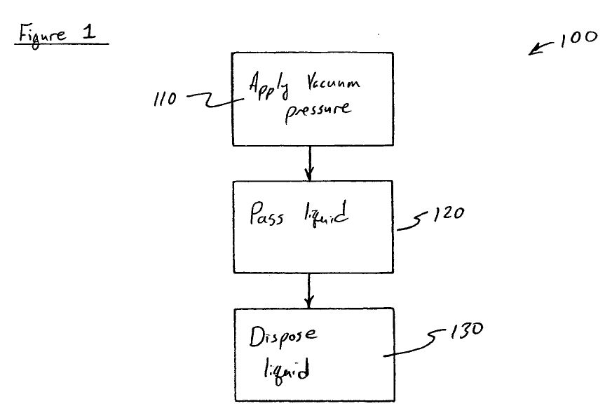

In one embodiment, the invention is a liquid transfer algorithm which generally defines acts which are performed to transfer a liquid, preferably between a mop bucket and a disposal. FIG. 1 is a flow diagram of a liquid transfer algorithm 100. The liquid transfer algorithm 100 begins with an apply vacuum pressure act 110. In the apply vacuum pressure at 110 a lower than atmospheric pressure is applied to a liquid, such as dirty water in a mop bucket. In one embodiment, the liquid is sucked into a receiving hose attached to an intake. The receiving hose may be either rigid or flexible hose. Next, the liquid transfer algorithm 100 proceeds to a pass liquid act 120.

In the pass liquid act 120 the liquid is transferred to, and then through a cleaning compound/fresh water device. The cleaning compound/fresh water device may be either located remotely from the mop bucket, such as on a wall or floor, or may be configured to removably couple to the mop bucket without the use of a rigid means of affixation, such as screws, welding, clamps or the like. In addition, pass liquid act 120 may provide for the treating, filtering, or altering of the liquid so that the device is not damaged. Then, following the pass liquid act 120, a dispose liquid act 130 takes place. In the dispose liquid act 130, the liquid is passed to a disposal, such as a sink, a drain in a floor, a basin, or a second mop bucket. The dispose liquid act 130 may also initiate the filling of the mop bucket with new, clean, fresh water from a water source (not the mop bucket).

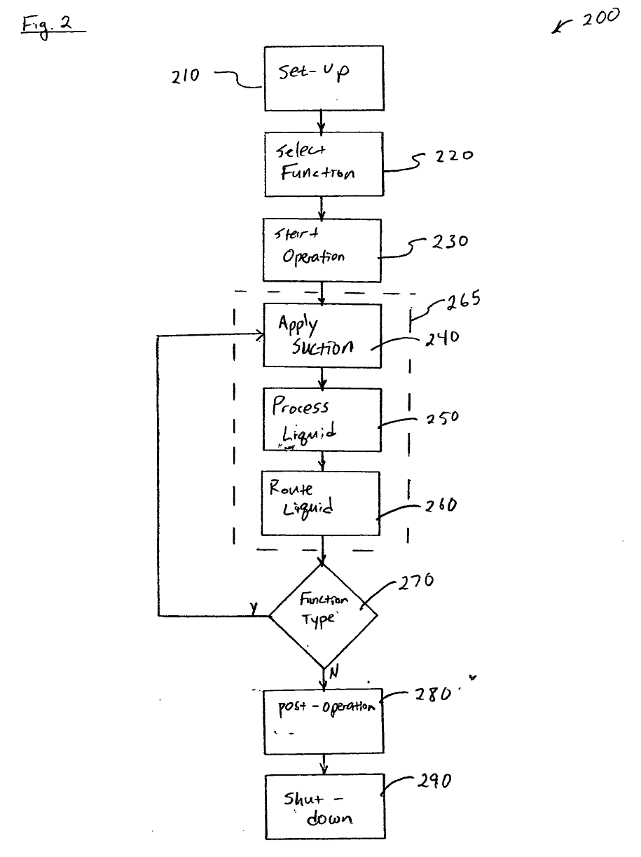

To more fully appreciate the invention, one may consider a cleaning station algorithm. FIG. 2 illustrates a cleaning station algorithm 200. The cleaning station algorithm 200 begins with a set-up act 210 which detects that a bucket containing dirty water is present at a mop station, preferably by detecting that a receiving or a disposing hose has been located in water, including dirty water. One way this could be accomplished is with a motion detector, completion of an electrical circuit in solution, or any of the numerous liquid and/or moisture detection means known, unknown, foreseeable or unforeseeable. Next, a select function 220 detects that a user has selected a predefined/preprogrammed function, or has programmed a function of his or her own such as a clean-and-fill with soapy water, clean-and-fill with water (hot or cold), or clean mop bucket functions, for example.

By further example, one function, called a fill function, may fill a mop bucket with water, such as in three gallon four gallon, five gallon, or metric increments. Another exemplary function is a drain and fill function in which the invention drains dirty water from the mop bucket and then fills the mop bucket with new, fresh, clean water. Another exemplary function is a drain, rinse, and fill function. In the drain, rinse, and fill function dirty mop water is drained from the mop bucket, then clean water is fed into the mop bucket so that the mop bucket will be rinsed, and then the rinse water is then drained from the mop bucket, and finally a liquid such as new, fresh, clean water, or soapy water, or sanitized water, for example, is placed in the mop bucket. Another exemplary function is a drain and rinse function. The drain and rinse function drains dirty mop water from a mop bucket and then flushes the mop bucket with new, fresh, clean water in order to rinse the mop bucket so that the mop bucket may dry. Yet another exemplary function is a sanitized mop function. The sanitized mop function removes dirty water from the mop bucket, and then flushes the mop with sanitized water. Preferably, one or more mops are left in the mop bucket so that the mops may also be sanitized. Still another exemplary embodiment of a function is a manual fill function. In the manual fill function dirty mop water is drained from the mop bucket so that a user may fill the mop bucket with their choice of liquids or compounds.

Following the select function act 220, a start operation act 230 takes place. In the start operation the pump begins operation by cleaning lines and performing system checks. Furthermore, the start operation act 230 may incorporate a time delay following the set-up act 210 before proceeding. Once the start operation 230 is completed, the cleaning station algorithm 200 proceeds to a liquid passage block 265. The liquid passage block 265 generally defines how a liquid is passed from one side of the cleaning compound/fresh water device to the other side of the cleaning compound/fresh water device.

The liquid passage block 265 begins with an apply suction act 240. In the apply suction act 240 suction is applied to dirty water in a mop bucket. Next, the liquid passage block 265 proceeds to a process liquid act 250. In the process liquid act 250 the liquid is transferred through a cleaning compound/fresh water device. In addition, in the process liquid act 250 the liquid may be treated, filtered, or otherwise altered as needed to prevent damage to the device. Then, following the process liquid act 250, a route liquid act 260 takes place. In the route liquid act 260, the liquid is passed to a disposal. The route liquid act 260 may also initiate the filling of the mop bucket with new, fresh, clean water, such as tap water.

Following the route liquid act 260, the cleaning station algorithm 200 leaves the liquid passage block 265 and proceeds to a function type query 270. If, in the function type query 270, it is determined that the function selected by a user which is detected in the select function act 220, requires another cleaning compound/fresh water device operation, then the cleaning station algorithm 200 proceeds along the y choice and returns to the apply suction act 240 of the liquid passage block 265. However, if in the function type query 270 it is determined that another cleaning compound/fresh water device operation is not needed, and then the printing station algorithm 200 proceeds along the n path to a post operation act 280. In the post-operation act 280 pumps and hoses are flushed in the direction of the disposal, and any needed system checks are performed. Then, the cleaning station algorithm 200 proceeds to shutdown act 290 in which the cleaning compound/fresh water system powers down, and the function selection is reset.

Exemplary Device

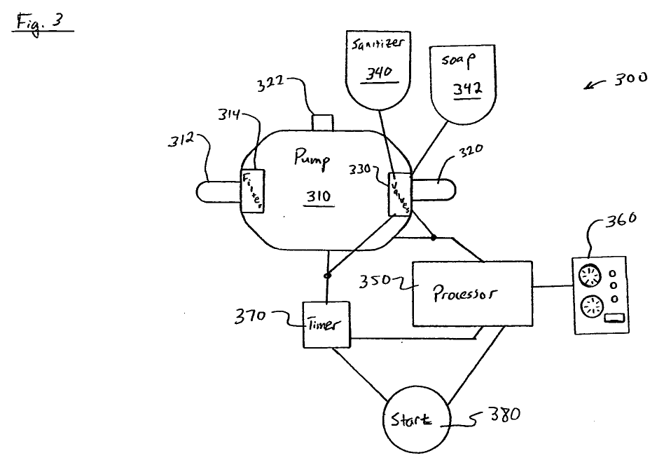

FIG. 3 is one embodiment of a cleaning compound/fresh water device 300 (the device) 300. The device 300 includes a pump, which is preferably an air pump, but which could be embodied as any type pump capable of transporting a liquid from an intake 312 such as a receiving hose attachment, to an outlet 320, such as a disposing hose attachment. In addition, it is preferable for the pump 310 to have a waterline attachment 322 coupled thereto, which may couple to a water tap. The pump 310 is either located remotely from the mop bucket, such as on a wall or floor, or may be configured to removably couple to the mop bucket without the use of a rigid means of affixation, such as screws, welding, clamps or the like. Removable coupling to a mop bucket can be achieved, for example, via a quick-release clamp, or a two-slit mount such as those used to mount a mop strainer to a mop bucket. In other words, the pump 310 is coupled to the waterline attachment 322 that is typically rigidly coupled to municipal water supply. Thus, the ability of the pump 310 to travel is limited by its being coupled to the waterline attachment 322, which is in one embodiment less than ten feet of hose.

Accordingly, the pump 310 does not travel with the mop bucket, and in this sense it is detached from (not attached to) the mop bucket. In addition, the pump 310 in one embodiment is coupled to a wall. In one embodiment the pump 310 stands from a floor (including on a table or on legs). In yet another embodiment the pump 310 is configured to set on the mop bucket, which in yet a further embodiment the pump 310 sits at least partially within a mop bucket. However, in no event should the pump be permanently or semi-permanently attached to the mop bucket through the use of screws, rivets, welding, or the like.

Preferably, a filter 314 is provided to remove large particulates from dirty water, such as mop bucket water, before the liquid passes through the pump so that the pump will not be damaged. However, it should be understood that the filter 314 may be used to remove particulate matter from any liquid passing through the pump 310. It is not desirable to return dirty water to the mop bucket, and so the pump 310 has a new, fresh, clean water system isolated from the parts of the system/pump that pass dirty water. In addition, the pump 310 maintains a plurality of valves 330 which may be articulated by a timer 370 or a processor 350.

The valves 330 open and close so as to allow a liquid to flow through the pump 310, and may be articulated to add a sanitizer, water, soap, or other compound to the liquid flowing through the pump 310. Accordingly, a valve is coupled to a sanitizer line 340, and a valve is coupled to a soap line 342. The sanitizer line 340 and the soap line 342 preferably lead to stationary containers of sanitizer and soap, but such containers of sanitizer or soap may also be maintained within chambers physically associated with the pump 310. A control system generally comprised of a processor 350, a timer 370, and a start button 380, is used to manipulate the valves 330 in the pump 310.

The processor 350 may be a digital signal processor (DSP), a general-purpose processor such as a Pentium Processor, or any other processing means. The timer 370 may be digital or an analog timer. The start button may be any electrical or mechanical device that sends a signal to the timer 370 or the processor 350 to instruct the cleaning compound/fresh water device 300 to begin operation. In addition, the start button 380 may include input devices capable of allowing a user to select a function, or to define or program a function. Accordingly, the start button 380 may be embodied as a keypad, a keyboard, or as a microphone used to pick up voice commands which are then processed by the processor 350. Furthermore, an indicator 360 is coupled to the processor 350. The indicator 360 may be embodied as a light emitting diode or as a plurality of light emitting diodes (LEDs), or as a liquid crystal display (LCD), or as a combination of LED/LCD devices. The indicator 360 may be used to display information provided by the timer 370. Accordingly, the indicator 360 may provide user visual information regarding the status of cleaning compound/fresh water device operation. The indicator 360 may also provide visual information regarding the operation or function being performed. Furthermore, the indicator 360 may be embodied as a speaker so that the cleaning compound/fresh water device 300 is enabled to provide user audible information regarding the status of operation.

Exemplary System

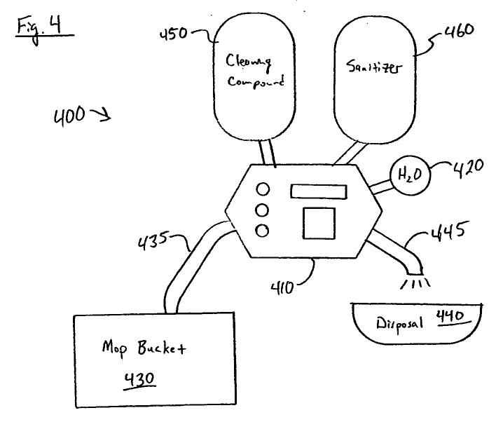

A cleaning compound/fresh water device may be better understood in the context of a cleaning compound/fresh water system embodiment of the invention. Accordingly, FIG. 4 shows a cleaning compound/fresh water system (the system) 400. The system 400 provides a cleaning compound/fresh water device embodied as a pump station 410. The pump station 410 is used to transfer dirty water between a mop bucket 430 and a disposal 440 that in one embodiment leads to a municipal sewer system, and between a fresh water hookup 420, such as a municipal water system (water tap for tap water), and the mop water bucket 430. The pump station 410 is located remotely from a mop bucket, such as on a wall or floor, except for the hoses that are used to draw dirty water from a mop bucket or to deliver new, clean, fresh water to the mop bucket.

Accordingly, a receiving hose 435 is coupled to the pump station 410 in such a way that the receiving hose 435 may also be removably disposed in a mop bucket, preferably in such a manner that most of a liquid may be removed from the mop water bucket 430 by applying a vacuum pressure to the liquid in the mop bucket 430. Means for removably coupling a hose to mop bucket include laying the hose in the mop buck, or securing to hose to the mop bucket with a quick-removal device, such as a clip. Likewise, a disposing hose 445 is coupled to the pump station 410 and is also positioned about the disposal 440. Accordingly, the disposal 440 may be a mop station sink, a sewer system line, or other disposal means, but is preferably a drain that leads to a municipal sewer system.

In order to provide a user with what is, in one embodiment, effectively a one-stop mop bucket station, containers are provided so that compounds may be added to water passing through the pump station 410. Preferably, these containers 450, 460 are either coupled to a wall or to a floor (including on a table or on support legs). Accordingly, a first solution container 450 is coupled to the pump station 410 via a valve. Similarly, a second solution container 460 maintains sanitizer solution or compound that may pass into the pump station 410 via a valve.

The methods may provide operations, such as a start operation. In addition, the invention may provide for a variety of functions, such as a select function, a set-up, a post operation, or a shut down. In selected embodiments, the invention may incorporate filtering a liquid, sanitizing the liquid, or adding a cleaning compound to the liquid. A timer may be provided for applying suction for a pre-determined period of time for either emptying a mop bucket or for filling the mop bucket. Furthermore, many other functions and operations may also be incorporated into the invention.

In operation, the pump station 410 has at least one hose 435 that may be dropped or set into a mop bucket 430. Dirty water is drawn through the receiving hose 435 and is disposed via the disposing hose 445. New, fresh, clean water is then drawn from the water supply 420. The new water may then be used to rinse the mop bucket 430 (rinse water is then drained), or may have an additive added to it to create sanitized, soapy, or otherwise treated water. Of course, the addition of water is not necessary, as one may wish for the mop bucket to dry. In a preferred embodiment, the system has a second hose between the mop bucket 435 and the pump station 410 (not shown, but readily understood by one of ordinary skill in the art upon reading the present disclosure), allowing for a more complete separation of new, fresh, clean water, or treated water, from dirty water headed for disposal.

Though the invention has been described with respect to specific preferred embodiments, many variations and modifications will become apparent to those skilled in the art upon reading the present application. It is therefore the intention that the appended claims be interpreted as broadly as possible in view of the prior art to include all such variations and modifications. Further, it is intended and understood that any of the teachings of any method, system or device has equal applicability to all other methods, systems or devices.

1. A method of operating a cleaning compound/fresh water device, comprising:
using a pump that is not attached to a mop bucket to apply a vacuum pressure to a liquid in the mop bucket;
passing the liquid through the pump; and
disposing the liquid away from the mop bucket.

2. The method of claim 1 further comprising filling the mop bucket with new water from a new water source.

3. The method of claim 2 wherein the new water source is attached to the pump via a hose, and the new water source is coupled to a municipal water supply.

4. A method of transferring a liquid between a mop bucket and a pump that is not attached to the mop bucket, comprising:
applying suction to a liquid in a mop bucket;
extracting liquid from the mop bucket;
routing the liquid to a disposal hose.

5. A method of claim 4 further comprising a start operation.

6. The method of claim 4 further comprising a select function.

7. The method of claim 4 further comprising a set-up.

8. The method of claim 4 further comprising a post operation.

9. The method of claim 4 further comprising a shut down.

10. The method of claim 4 further comprising a filtering liquid.

11. The method of claim 4 further comprising applying suction for a pre-determined period of time for either emptying a mop bucket or filling the mop bucket.

12. The method of claim 4 wherein the start operation begins in response to a detection of a liquid.

13. The method of claim 4 further comprising:
receiving new water from a new water supply; and
routing the new water to a hose set in the mop bucket.

14. The method of claim 13 further comprising sanitizing the new water.

15. The method of claim 13 further comprising adding a cleaning compound to the new water.

16. A cleaning compound/fresh water system, comprising:
an first intake coupled to a new water source;
an second intake coupled to a hose that is adapted to rest in a mop bucket;
a pump enabled to pump liquids coupled to the intake; and
a first outlet coupled to an outlet hose that is adapted to rest in the mop bucket; and
a second outlet coupled to a disposal hose that is configured to send dirty water to municipal sewer system.

17. The system of claim 16 further comprising a timer coupled to the pump, a timer for controllably turning on and off the pump so that a direction of liquid flow and duration of liquid flow may be controlled.

18. The system of claim 17 further comprising a means for adding a solution to the liquid.

19. The system of claim 16 further comprising a filter coupled to the pump.

20. The system of claim 16 further comprising a processor for controlling the functionality of the pump, the processor coupled to the pump.
